(19) United States
(12) Patent Application Publication
(10) Pub. No.: US 2002/0048144 A1
(43) Pub. Date: Apr. 25, 2002

(54) Activated carbon, process for producing the same, polarizable electrode, and electric double layer capacitor

(75) Inventors: Nozomu Sugo, Okayama-ken (JP); Hideharu Iwasaki, Okayama-ken (JP); Goki Uehara, Okayama-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kuraray Co., Ltd. Kurashiki-shi Japan

(21) Appl. No.: 09/911,483

(22) Filed: Jul. 25, 2001

(30) Foreign Application Priority Data
Jul. 25, 2000 (JP) 2000-223680

(51) Int. Cl. B01J 20/02

(52) U.S. Cl. 361/502; 502/416; 502/418; 502/427; 502/425; 502/426; 429/231.8

(57) ABSTRACT

An activated carbon which is prepared from granular isotropic pitch.

### BACKGROUND OF THE INVENTION

1. Field of the Invention:

The present invention relates to activated carbon, which is made from granular isotropic pitch; a process for producing the same; a polarizable electrode; and an electric double layer capacitor. By fabricating polarizable electrodes from the activated carbon of the present invention and combining the electrode with current collectors and an electrolyte, a capacitor which has a large capacitance and which possesses superior low-expandibility at the time of charge and discharge can be made.

2. Description of the Background:

In recent years, attention has been directed to an electric double layer capacitor as a component of back-up power sources, auxiliary power sources, and the like. A wide area of investigation has been directed to the development of electrodes prepared from activated carbon of improved performance for use in the fabrication of electric double layer capacitors. Since an electric double layer capacitor using activated carbon as the active material of polarizable electrodes generally exhibits superior electrostatic capacity, the use of these improved capacitors has stimulated developments in the field of electronics which is evidenced by the markedly increased use of these capacitors in electric devices. In recent years, conventional memory back- up power sources have been reduced in size and further large-capacitance products that are used in auxiliary electrodes of the likes of motors have been developed.

When different two layers, for example, a solid electrode and an electrolyte solution are brought in contact with each other, positive and negative charges are arranged and distributed at the interface of these components at a very short interval. When a voltage is applied between the electrodes of an electrochemical device so that the electrodes are charged, ions are arranged in the electrolyte solution in order to compensate for electric charges. Such an ion-arranged or dispersed layer is an electric double layer. The device in which the capacitance of the electrode interface, resulting from the formation of the electric double layer, is used is an electric double layer capacitor.

Electric double layer capacitors (condensers) have been known in the past which have cylinder-type, lamination-type and coin-type structures. FIG. 1 schematically illustrates an electric double layer capacitor having the coin-type structure. In FIG. 1, reference numbers 1 and 2 indicate current collectors made of aluminum mesh or the like; 3 and 4, polarizable electrodes; 5, a separator made of nonwoven polypropylene fabric or the like; 6, a gasket made of polypropylene or the like; and 7, a case made of aluminum or stainless steel. Members 1 and 2 are brought into contact with the polarizable electrodes 3 and 4, respectively, so that members 1 and 2 become current collectors for the respective polarizable electrodes and can function as connecting-terminals of an external circuit. In such a way, an electric double layer capacitor has, in a case, a pair of polarizable electrodes made of activated carbon powder or fiber and a separator therebetween, which is porous and which has ion-permeability. The polarizable electrodes and the separator are wetted by the electrolyte solution. If necessary, current collectors are inserted between the polarizable electrodes and the case or they are deposited on the electrodes. In these cases, the opening between the upper lid and the lower case is sealed with a sealing member so that the electrolyte solution does not leak from the device.

Electric double layer capacitors generally have better instantaneous charge and discharge abilities than batteries, and exhibit only small deterioration upon repeated charge and discharge cycles, and further do exhibit overvoltage at the time of charging and discharging of the capacitors. Therefore, a feature of the electric double layer capacitor is that electric circuits containing the capacitor can be made simple. Moreover, the remaining capacitance of the electric double layer capacitor can easily be known and the endurance temperature thereof is wide.

The use of such electric double layer capacitors as the memory of microcomputers or an IC, as the back-up power source in a timer section or other control sections, as the power source in electrical equipment, as a power source when electricity is cut off, as a power source adapted for cars, and the like, has been investigated. However, the use of capacitors of this type has only achieved partial success. The electric double layer capacitor has been required to be light or compact. That is, an improvement in the capacitance of its electric double layer, per unit volume and per unit weight, has been demanded.

In order to improve the electrostatic capacitance of an electric double layer capacitor, the study of the materials of the components which constitute the capacitor is important. For example, with respect to the material of the polarizable electrode, which is one of the components of the capacitor, it is important that the material has a large specific surface area, a large bulk specific gravity, electrochemical inactivity, small resistance and so on. The matter of the use of activated carbon as a suitable material which satisfies such requirements, and more particularly the use of activated carbon powder obtained by carbonizing and activating a plant material such as wood meal, are discussed on page 68 of “Technologies & Materials for EDLC” published by CMC (the first issue published on Oct. 26, 1998).

JP 11-135380 discloses a process for producing activated carbon, which material is different from the above-mentioned activated carbon, in that a meso phase resin obtained by cooling and solidifying a meso phase extracted from petroleum pitch is used. The document discloses a polarizable electrode and an electric double layer capacitor made from the activated carbon.

JP 10-199757 discloses a process of carbonizing a material comprising petroleum coke or coal pitch coke in the atmosphere of an inert gas and then activating the carbonized material with an alkali metal hydroxide to produce carbon material for an electric double layer capacitor having a high electrostatic capacitance. High-capacitance activated carbon obtained by heat-treating petroleum coke, meso phase carbon fiber (MCF) or infusible vinyl chloride beforehand at 600-900° C. and activating the treated material with potassium hydroxide is described on pages 82 to 64 of “Electric Double Layer Capacitor and Electricity Storing System” published by Nikkan Kogyo Newspaper Publishing Company (1999). The matter that an electrode made of the activated carbon expands at the time of charge so that the thickness thereof will be 1.5 to 3 times is also described therein.

JP 11-317333 discloses a material which exhibits a large electrostatic capacitance as an 20 electric double layer capacitor electrode and states that the thickness of the electrode expands in the same way as above when a voltage is applied thereto.

However, the activated carbon materials disclosed in these publications are activated carbons made from anisotropic pitch, that is, meso phase and, pitch, phenol resin, or petroleum pitch as raw materials, and the activated carbons are different from the activated carbon of the present invention, which is made from isotropic pitch.

It is said that the electrostatic capacitance of activated carbon used in an electric double layer capacitor is in direct proportion to its specific surface area. In fact, in order to increase the electrostatic capacitance if the capacitor, development has been made with efforts to increase the specific surface areas of the activated carbon. However, recent research suggests that in order to increase electrostatic capacitance, it is important to investigate factors other than the specific surface area (see, for example, “DENKI KAGAKU” Vol. 66, No. 12, pages 1311-1317 (1998)). Important such factors include improvement of the specific surface area of the activated carbon and a study of the materials used and production procedures in the preparation of the activated carbon.

JP 11-293527 discloses that isotropic pitch is used as material for the production of activated carbon. This publication states that an electric double layer capacitor having a large electrostatic capacitance can be made using activated carbon fiber obtained by pulverizing optically isotropic pitch type infused fiber into pieces having an average particle diameter of 5 to 50 μm and activating the resultant pieces of the fiber with an alkali. However, in order to maintain the spinnability of an optically isotropic pitch type fiber as described in this publication, it is necessary to suppress the generation of over-polymerized materials or volatile substances, which result in a drop in the spinnability of the optically isotropic pitch as raw material of the activated carbon, or to control the softening point precisely, as described in “TANSO” No. 193, pages 180-185(2000). It is also necessary to keep the strength required for the step of winding the fiber into a nonwoven fabric, which step is subsequent to the spinning step.

As described above, in order to prepare activated carbon for the polarizable electrodes of the electric double lager capacitor disclosed in the publication, it is important to produce stably spinnable optically isotropic pitch, which makes it possible for one of skill to avoid the problems mentioned above. Furthermore, it is essential to provide stable conditions in the step of producing such a spinnable optically isotropic pitch and during the step of making the pitch into fiber. Thus, complicated processing is necessary. This leads to increased costs of production which makes the process expensive. It is difficult to say that the method disclosed in the publication is industrially profitable. The fiber has an anisotropic shape and it also has an orientation when it is spun, so that the reactivities of the major axis and the short axis of the fiber are different from each other. Therefore, at the time of making the fiber infusible, the amount of oxygen introduced from the surface of the fiber along the short axis direction of the fiber may be different from the amount of oxygen along the major axis direction of the fiber. The fiber- activated degrees (for example, structural changes) when the fiber is activated may be different in the short axis direction of the fiber and in the major axis direction of the fiber. The fiber may exhibit poor workability because the fiber has an anisotropic shape.

It is known that the material of an electrode of a capacitor may expand, particularly at the time the capacitor is charged, which expansion may deform the capacitor and give rise to leaking of electrolyte solution from the sealed opening of the capacitor. Therefore, an important factor to consider in capacitor construction is to suppress the expansion of the electrode or to provide the device with a volume which allows the electrode to expand into, thereby eliminating the possibility of deformation of the capacitor.

### SUMMARY OF THE INVENTION

Accordingly, one object of the present invention is to provide activated carbon having a large electrostatic capacitance and which, when shaped into an electrode and employed in the fabrication of an electrochemical cell, only undergoes small expansion, and a process for producing activated carbon which requires neither a fiber-forming step nor complicated processing.

Another object of the present invention is to provide a polarizable electrode and an electric double layer capacitor which are formed from the activated carbon.

Briefly, these objects and other objects of the present invention as hereinafter will become more readily apparent can be attained by an activated carbon which is formed from granular isotropic pitch.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view of an example of activated carbon of the present invention in the form of an electrode of a capacitor; and

FIG. 2 is a schematic view of another example of activated carbon of the present invention in the form of an electrode of a capacitor.

### DETAILED DESCRIPTION OF THE PREFERRED EMBODIMENTS

It has now been discovered that the objectives sought after in the preparation of an activated carbon can be found in a granular activated carbon which is made from isotropic pitch and wherein, in the preparation of the carbon material, a fiber formation step is not required. Thus, the inventors have made the present invention. That is, the activated carbon of the invention is prepared from granular isotropic pitch.

Another aspect of the present invention is a process for producing activated carbon, wherein granular isotropic pitch is activated with a chemical agent.

Still another aspect of the present invention is a polarizable electrode produced by mixing the above-mentioned activated carbon with at least a binder and an electroconductive filler.

Yet another aspect of the present invention is an electric double layer capacitor composed essentially of a pair of polarizable electrodes, a current collector set onto each of the polarizable electrodes, and an electrolyte solution, wherein at least one of the polarizable electrodes is the above-mentioned polarizable electrode.

The activated carbon of the present invention is made from granular isotropic pitch. Isotropic pitch can be obtained from natural pitch or synthetic pitch. Examples of natural pitch include coke such as petroleum coke, coal coke and pitch coke; pitch such as petroleum pitch and coal pitch; and heavy oils such as petroleum distillation residue, naphtha thermal-decomposition residue, ethylene bottom oil, liquefied coal oil, and coal tar. Examples of the synthetic pitch include polymers obtained from an aromatic compound such as naphthalene or anthracene.

The following methods may be used to produce the isotropic pitch of the invention:

Heat-treating coal tar pitch or the decomposition residue oil of petroleum at 350° C. to 500° C. until small spheres of a meso phase are produced, extracting the meso phase material with a solvent to extract and remove solvent-insoluble components from the meso phase, and then heat-treating the resultant at 350° C. to 540° C.;

Employing a nitro compound as a softening point increasing agent or a polymerization promoter;

Adding a nitro compound as a polymerization promoter to tar, pitch or the like, 5 and heat-treating the resultant product at 100° C. to 400° C. while blowing gas comprising oxygen or ozone therein. To make the steps simple, it is preferred that coal pitch coke, petroleum coke or the like is heat-treated while gas comprising oxygen and an optional polymerization promoter are introduced therein. The thus produced isotropic pitch usually has a softening point of 200° C. or higher.

The most significant characteristic of the present invention is the use of granular isotropic pitch as the raw material for activated carbon. In the present invention, the granular isotropic pitch is solid isotropic pitch having an average particle diameter of 10 mm or less, preferably 5 mm or less. The word “granular” in the present invention includes the meaning of a fine powder having an average particle size of 400 μm or less, 20 μm or less, 10 μm or less, or the like. To convert isotropic pitch into such a granular form, it is advisable to pass isotropic pitch, when produced, through nozzles. Another method is to remove isotropic pitch in lump form and then pulverize the pitch. Other methods can be employed. By using such a granular isotropic pitch, the process for producing activated carbon is made simple, and costs for the production are reduced. Moreover, the activated carbon fabricated as an electrode results in a capacitor of high electrostatic capacitance. The activated carbon may also be readily shaped with good workability into an electrode, and exhibits low-expandibility. In the instance of removing the pitch in lump form and pulverizing the pitch into a powder, the step may be conducted before conversion of the pitch into an infusible state, which will be described after, before heat-treatment, before activation, or after the activation. Preferably, the step is performed before conversion of the pitch into an infusible state, or before activation.

In the case the polarizable electrodes of an electric double layer capacitor are formed from the activated carbon of the present invention, the specific surface area of the activated carbon is preferably set at 50 to 4000 m²/g, because the activated carrion exhibits a high electrostatic capacitance, and more preferably ranges from 100 to 2500 m²/g. This specific surface area can be measured, for example, by the known BET method based on nitrogen adsorption. The total amount of functional groups of the surface of the activated carbon is preferably set to 2.5 meq/g or less. If the total amount is 2.5 meq/g or more, the endurance of the capacitor may drop. The total amount of functional groups on the surface of the activated carbon can easily be determined by titration with hydrochloric acid.

In the activated carbon of the present invention, the half band width of a peak indicating the D band (near 1250 cm⁻¹) of amorphous carbon in Raman spectra is preferably 1 to 4 times larger than the half band width of a peak indicating the D band (near 1300 cm⁻¹) of graphite carbon. The peak of the D band of amorphous carbon and the peak of the D band of graphite carbon can be obtained by subjecting each of the peaks near 1550 cm⁻¹ and near 1350 cm⁻¹ to a curve-fitting treatment, using a Gaussian function, and thus dividing them into four components, that is, a peak indicating the D band of amorphous carbon, a peak indicating the D band of graphite carbon, a peak indicating the G band of amorphous carbon, and a peak indicating the G band of graphite carbon. In other words, when, Nd³⁺:YAG laser having a wavelength of 532 nm and a CCD are used as exciting light and a detector, respectively, the half band width of the peak indicating the D band of amorphous carbon is more preferably 1-3.5 times larger than that of the peak indicating the D band of graphite carbon.

In order to obtain the activated carbon of the present invention, which is made from granular isotropic pitch, it is sufficient to activate granular isotropic pitch. However, in order to achieve the objective of a high electrostatic capacitance, the pitch is preferably activated with a chemical agent. If the surface of the pitch is partially oxidized in the process for producing activated carbon of the present invention, which makes the pitch infusible (that is, the grains which constitute the pitch do not adhere to each other as a result of oxidization of the surfaces of the grains), melt adhesion between the granules can by prevented. Therefore, it is preferred that the granular isotropic pitch initially be converted into such an infusible state that the pitch does not dissolve at the time of activation, and subsequently the pitch is activated with a chemical agent. In the instance that the average particle diameter of the granules is about 20 μm, the amount of oxygen present in the pitch, as a criterion for conversion into the infusible state, depends on the fineness (granularity) of the isotropic pitch, and is desirably set at 1.5% to 10% by weight. If the amount of oxygen is 10% or more by weight, the yield of the pitch at the time of conversion into the infusible state may be largely lowered. If the amount of oxygen is less than 1.5% by weight, the grains may adhere to each other.

The manner of conversion into the infusible state is not limited, and may be, for example, a manner of heating the pitch in the presence of gas containing oxygen. The conditions for conversion into the infusible state depend on the required amount of oxygen which is introduced for reaction with the pitch, the amount of the isotropic pitch, the partial pressure ratio of oxygen gas, the flow rate of the gas, the temperature and so on. In general, the temperature of the pitch is increased to a temperature below 800° C., preferably a temperature within the range of 250° C. to 600° C. in the presence of gas containing oxygen, for example, air, and then this temperature is held from 5 minutes to 15 hours. If the temperature is over 600° C., the yield of the pitch after conversion of the pitch into the infusible state, which depends on conditions such as the partial pressure of oxygen gas, may be lowered.

The infusible granular isotropic pitch may be activated as it is, but the pitch may be heat- treated within the range of 600° C. to 1000° C., in the atmosphere of an inert gas in order to remove volatile substances or to improve the capacitance per volume. If the heat-treating temperature is higher, the tendency of the electrodes formed from the carbon to expand at the time of charging a capacitor containing the electrodes is large or the activation of the carbon does not proceed easily. Preferably, the granular isotropic pitch is rendered infusible under the above-mentioned conditions and further after heat-treatment under the above-mentioned conditions the pitch is activated with a chemical agent to produce activated carbon.

Examples of the manner of activation include (i) performing activation with oxidizing gas, for example, steam, CO₂ gas, air, a gas generated when a combustion gas such as LPG is burned, or a mixed gas thereof; and (ii) performing activation by adding a chemical agent such as zinc chloride, potassium hydroxide, sodium hydroxide, phosphoric acid, calcium chloride, potassium sulfide, or sulfuric acid to the granular pitch. The activation is preferably performed in a flow of an inert gas, CO₂ gas, or an inert gas containing steam. Activation in a flow of an inert gas is preferred from the viewpoint of safety. This is because such activation can prevent explosion or concurrence of reactions such as combustion. If the activating temperature is too low, the advance of the activation is slow which means that long times are required for activation. If the activating temperature is too high, the diameter of the pores which form may be too large in the instance where the resultant activated carbon is used as the material from which the polarizable electrode of an electric double layer capacitor is prepared. Therefore, the activating temperature usually ranges from 600° C. to 950° C., preferably 600° C.. to 850° C.

If a gas is used to perform the activation, a preferred example of activating conditions, which depend on the kind of the used gas or the partial pressure ratio thereof, is that the pitch is heated to a temperature at 500° C. to 1000° C. in an atmosphere of the oxidizing gas for 1 to 8 hours, for example. If the activating temperature is below 500° C., the electrostatic capacitance which can be substantially taken out may be low because of insufficient electroconductivity, which results from insufficient aromatization of the pitch. On the other hand, if the activating temperature is over 1000° C., control of the activation may be difficult which means that a homogeneous activated carbon may not be obtained.

Suitable examples of the activating chemical agent for the pitch include metal chlorides such as zinc chloride, calcium chloride and magnesium chloride; mineral acids such as phosphoric acid, sulfuric acid, and hydrochloric acid; hydrogen salts of mineral acids such as potassium hydrogensulfate, sodium hydrogensulfate, ammonium hydrogensulfate, disodium hydrogenphosphate, dipottasium hydrogenphosphate, diammonium hydrogenphosphate, potassium hydrogenphosphate, sodium hydrogenphosphate, and ammonium hydrogenphosphate; salts such as potassium sulfate, sodium sulfate, ammonium sulfate, potassium phosphate, sodium phosphate, and ammonium phosphate; carbonates such as sodium carbonate, potassium carbonate, calcium carbonate, and magnesium carbonate; and salts such as potassium sulfide, potassium thiocyanate, potassium hydroxide and sodium hydroxide.

In the instance activation by use of a chemical agent is adopted, a chemical agent is preferably employed, in order to result in a high electrostatic capacitance, at least one part of which is a compound comprising an alkali metal element, a compound comprising an alkaline earth metal element, zinc chloride, sulfuric acid, or phosphoric acid. It is more preferred to use, as the chemical agent, potassium hydroxide or sodium hydroxide. Activation with a chemical agent is performed preferably at a temperature of 500° C. to 900° C., more preferably at a temperature of 600° C. to 800° C. If the amount of the chemical agent used is too small, the degree of activation is low so that electrostatic capacitance tends to be small. If the amount is too large, the pitch is excessively activated so that the bulk density of the activated carbon becomes small and the electrostatic capacitance per volume tends to be small. Thus, the amount of the chemical agent usually ranges from 100 to 400 parts by weight, preferably 110 to 240 parts by weight relative to 100 parts by weight of the isotropic pitch.

Upon the addition of the chemical agent, the agent in solid form may be mixed, as it is, with the activated carbon, or the agent may be in the form of an aqueous solution as it is added to the activated carbon. Needless to say, when the agent is added as an aqueous solution, the same effects as in the case of the addition of the chemical agent in solid agent are exhibited. At the time of the activation, the chemical agent is preferably positively mixed with the activated carbon while the chemical agent is dissolved. Such operation makes it possible to provide a uniform degree of activated carbon, so that a drop in the electrostatic capacitance can be prevented. The time when the activating temperature is maintained is set to 20 hours or less, preferably 10 hours or less.

If the activating step in the present invention is performed through (i) a pitch-moistening step in which at least the surface of a granular mixture of isotropic pitch and a chemical agent are moistened at a temperature of 200° C., or lower, (ii) a step in which the pitch is solidified by eliminating the moistened state at a temperature of 400° C. or lower, or (iii) a pitch-heat-treating step in which the solid is heat-treated at a temperature over 400° C. while maintaining the solid state, corrosion of the production machine can be reduced. Such a case is preferred. It is more preferred to eliminate the moistened state at a temperature of 250° C. or lower. The wording “the surface of the pitch is in a moisture state” or any similar such wording, in the present text, means that the surface of the mixture of the pitch and the chemical agent is kept in a solid state, but looks wet when the surface is observed with the naked eye. The wording “the moisture state is eliminated into a solid state” or any similar wording means that the surface of the solid is in a dry state.

CO₂ gas, CO₂ gas containing water vapor gas, an inert gas or the like is introduced into the resultant activated carbon, and subsequently the activated carbon is supplied to a refining step in which the carbon is washed with water, washed with an acid, washed with an alkali, pulverized, granulated, dried or the like, or a secondary working step. In the refining step, the amount of heavy metals is set at 100 ppm or less, preferably 50 ppm or less. If the amount of remaining metals is large, the metals may result in undesirable short circuits. The thus obtained activated carbon is mixed with an electroconductive filler such as carbon black, and a binder so as to form a paste, and then the paste is applied to a current collector. Thereafter, the resultant laminate is pressed to form a coat electrode. The paste or the materials kneaded in a dry state are formed into a sheet. The resultant sheet is used as a sheet electrode. Upon admixture, an organic solvent such alcohol or N-methylpyrrolidone, a solvent such as water, a dispersing agent, any one of various additives, and so on may be used if necessary. Such an electrode is particularly useful as at least one polarizable electrode of an electric double layer capacitor. To obtain a highly useful electric double layer capacitor having a high electrostatic capacitance per volume, in each of polarizable electrodes the electrode density thereof is preferably set at 0.3 g/m³ or more, more preferably at 0.5 g/m³.

Suitable examples of the binder include polyvinylidene fluoride, polytetrafluoroethylene, vinylidene fluoride-hexafluoropropylene copolymer, polytrifluorochloro ethylene, isoprene rubber, butadiene rubber, ethylene-propylene rubber, nitrile rubber, chloroprene rubber, acrylonitrile-butadiene-styrene copolymer, polyester, polyamide, and polycarbonate. The binder may be added as a powder or in the form of an emulsion.

Suitable examples of a solvent for the electrolyte used in the present invention include carbonates such as dimethylcarbonate, diethylcarbonate, ethylenecarbonate, and propylenecarbonate; nitrites such as acetonitrile, and propionitrile; lactones such as γ-butyrolactone, α-methyl-γ-butyrolactone, β-methyl-γ-butyrolactone, γ-valerolactone, and 3-methyl-γ-valerolactone; sulfoxides such as dimethylsulfoxide, and diethylsulfoxide; amides such as dimethylformamide, and diethylformamide; ethers such as tetrahydrofuran, and dimethoxyethane; and sulfolanes such as dimethylsulfolane, and sulfolane. These organic solvents may be used alone, or as a mixture of two or more solvents selected from these solvents.

Examples of the electrolyte dissolved in these organic solvents include ammonium tetrafluoroborates such as tetraethyl ammonium tetrafluoroborate, tetramethyl ammonium tetrafluoroborate, tetrapropyl ammonium tetrafluoroborate, tetrabutyl ammonium tetrafluoroborate, trimethylethyl ammonium tetrafluoroborate, triethylmethyl ammonium tetrafluoroborate, diethyldimethyl ammonium tetrafluoroborate, N-ethyl-N-methylpyrrolidinium tetrafluoroborate, N,N-tetramethylenepyrrolidium tetrafluoroborate, and 1-ethyl-3-methyl imidazolium tetrafluoroborate; ammonium perchlorates such as tetraethyl ammonium perchlorate, tetramethylammonium perchlorate, tetraprapylammonium perchlorate, tetrabutylammonium perchlorate, trimethylethyl perchlorate, triethylmethylammonium perchlorate, diethyldimethylammonium perchlorate, N-ethyl-N-methylpyrrolidinium perchlorate, N,N-tetramethylenepyrrolidium perchlorate, and 1-ethyl-3-methylimidazolium perchlorate; ammonium hexafluorophosphate such as tetraethylammonium hexafluorophosphate, tetramethylammonium hexafluorophosphate, tetrapropylammonium hexafluorophosphate, tetrabutylammonium hexafluorophosphate, trimethylethylammonium hexafluorophosphate, triethylmethylammonium hexafluorophosphate, and diethyldimethylammonium 5 hexafluorophosphate; lithium hexafluorophosphate; and lithium tetrafluoroborate.

The concentration of the electrolyte preferably ranges from 0.5 to 5 moles/liter (M/L), and is particularly preferably from 1 to 2.5 M/L. If the concentration of the electrolyte is below 0.5 M/L, the electrostatic capacitance may drop.

As described above, the activated carbon of the present invention can be used by mixing a binder and an electroconductive filler in a solvent and forming the resultant solution into a polarizable electrode such as a coat electrode or a sheet electrode by any known method. An electric double layer capacitor can be composed of a pair of such polarizable electrodes, a current collector set onto each of the polarizable electrodes, and an electrolyte solution, and the coat electrode or the sheet electrode can be used as at least one of the polarizable electrodes. In this electric double layer capacitor, it is desired from the viewpoint of mechanical strength that the expansion coefficient of its polarizable electrodes, after charging and discharging, be as low as possible. In the electric double layer capacitor of the present invention, the expansion coefficient of its polarizable electrodes after charging and discharging preferably is 40% or below, more preferably 0% to 20%. Thus, the electric double layer capacitor possesses superior low-expandibility.

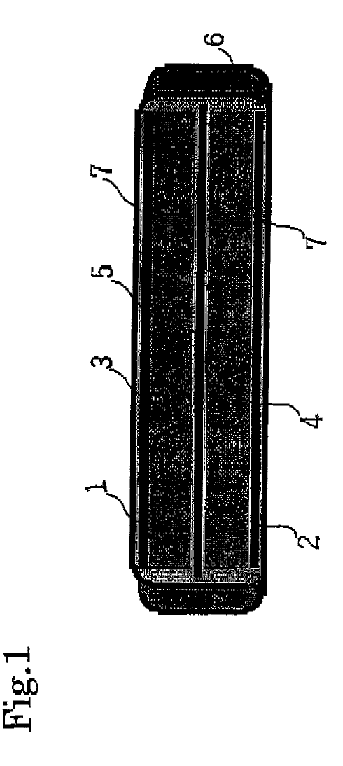

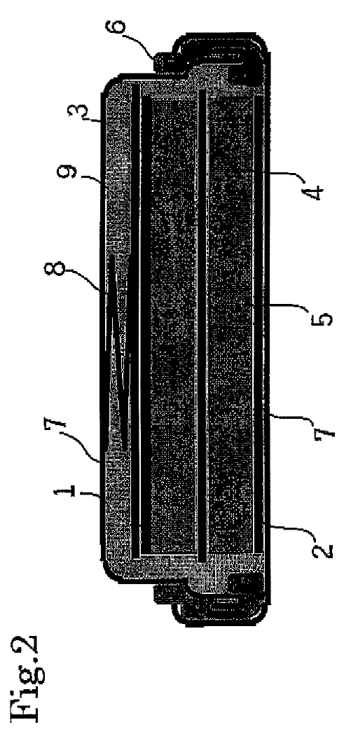

The outline of an example of the electric double layer capacitor is illustrated in FIG. 1. FIG. 2 illustrates another example of the electric double layer capacitor of the present invention. Reference numbers 8 and 9 in the figures represent a pressure adjusting spring and a pressure plate, respectively.

Having now generally described this invention, a further understanding can be obtained by reference to certain specific examples which are provided herein for purposes of illustration only and are not intended to be limiting unless otherwise specified.

### EXAMPLES

### Example 1

Isotropic pitch (softening point: 297° C.), which had an oxygen concentration of 1.5% and was obtained from coal pitch coke was made infusible and pulverized to give isotropic pitch powder having an average particle size of 20 μm. Into a cylindrical reaction tube, which was made of Hastelloy and had an inner diameter of 47 mm, were placed 6 g of the resultant infusible isotropic pitch powder (oxygen concentration: 3.0%) and 12 g of pulverized potassium hydroxide. The temperature of the system was increased from 200° C. to 700° C. at a rate of 200° C./hour in the current of nitrogen (flow rate: 300 mL/minute). Thereafter, the increased temperature was held for 1 hour to activate the isotropic pitch. While the content in the tube was in the state of a slurry, that is, after the oven temperature reached 390° C., the contents were stirred for 30 minutes. After the activation, the content was cooled and then CO₂ gas was introduced into the reaction tube.

Next, nitrogen gas was allowed to flow into a bottle containing pure water, and the nitrogen gas containing water vapor produced was passed into the reaction tube. The contents of the tube were washed with an aqueous alkali, washed with water and then washed with 0.1 N hydrochloric acid solution. The contents of the tube were then washed with water to remove metal components. Thereafter, the washed product was dried by a hot-wind drier and a vacuum drier, to give activated carbon. The specific surface area of the activated carbon was measured, and determined to be 2060 m²/g. Furthermore, 25 ml of a 0.1 M/L solution of sodium ethoxide in ethanol was added to 500 mg of the activated carbon. The solution was stirred for 16 hours and subsequently this solution was filtered and titrated with a 0.1 N hydrochloric acid. In this 5 way, the amount of all functional groups on the surface of the activated carbon was calculated per unit weight of the activated carbon, and was determined to be 1.9 meq/g. The Raman spectrum of the activated, carbon was measured with a Raman spectroscopic photometer Holoprobe 532 product by Kaiser (exciting light: Nd³⁺: YAG laser having a wavelength of 532 nm, detector: charge coupled device, and laser power: 4 to 10 mW). Peak-division was performed, using a Gaussin function. The half band width of the peak indicating the D band of amorphous carbon was divided by that of the peak indicating the D band of graphite carbon. The resultant value (abbreviated as the D ratio hereinafter) was 2.8. The measurement was performed under the condition of N=3. The average value thereof was adopted.

To this activated carbon were added polytetrafluoroethylene [“Teflon 6J” (trade name; product by Mitsui Dupont Chemicals)] and an electroconductive filler [“Denka Black” (trade name; product by Denki Kagaku Kogyo Kabushiki Kaisha)], so that the activated carbon: the polytetrafluoroethylene: the electroconductive filler was 81:10:9 (weight ratio). The mixture was kneaded and formed into a sheet. The sheet was punched out to give circular polarizable electrodes having a diameter of 11 mm. The electrodes were vacuum-dried and transferred to a glove box having a dew point of −80° C. or lower.

Subsequent working concerned with cell-production was performed in the glove box. The thickness and the weight of the electrodes were measured after the dying in order to calculate the electrode density of the polarizable electrodes.

An electrolytic solution for use was a 1 M/L solution of tetraethylammonium tetrafluoroborate in propylene carbonate. The polarizable electrodes were immersed in the electrolytic solution in vacuum for 30 minutes. As separators, two glass filters [“GB100R” (trade name; product by ADVANTEC)], each having a diameter of 13 mm upon being punched-out, were used. These members and an HS cell product by Hohsen Corp. were used to fabricate a capacitor. The fabricated capacitor was charged at a charge voltage of 2.7 V and a charge current of 3 mA. Thereafter, the capacitor was charged at a constant voltage of 2.7 V until a current of 1 mA resulted. Subsequently, the capacitor was discharged at a constant current of 3 mA. This process was repeated. From the inclination of 1.2 V to 1.0 V in the sixth cycle thereof, the electrostatic capacitance of the capacitor was obtained. The result is shown in Table 1. After charging and discharging, the electrodes were removed, and then the expansion coefficient of the electrodes was calculated from the following equation;

(electrode thickness after charging and the discharging-electrode thickness before immersion into the electrolytic solution)/(electrode thickness before immersion into the electrolytic solution).

### Example 2

Activated carbon was prepared in the same manner as described Example 1, except that the temperature of the system was increased from 200° C. to 800° C. over 3 hours and then the raised temperature was held for 2 hours (yield: 74%). Electrode density, electrostatic capacitance, specific surface area and the total amount of functional groups, and the D ratio as determined are shown in Table 1.

### Example 3

Activated carbon was prepared in the same manner as described in Example 1, except that isotropic pitch which was rendered infusible and had an oxygen concentration of 5%, a softening point of 262° C. and an average particle diameter of 12 μm was used. The results obtained are shown in Table 1.

### Example 4

The isotropic pitch used in Example 8 was placed on a quartz glass boat, and the boat was introduced into a tubular reaction furnace having an inner diameter of 4.7 cm. The temperature of the furnace was increased up to 700° C. at a rate of 200° C./hour in the current of nitrogen (flow rate a 500 mL/minute), and this temperature was held for 2 hours. Thereafter, the pitch was cooled and pulverized into powder having an average diameter of 6 μm. Thus, isotropic pitch subjected to the heat-treatment was obtained (yield: 80%). Activation was performed in the same way as described in Example 1, to give activated carbon, The results obtained are shown in Table 1.

### Example 5

Activated carbon was prepared in the same manner as described in Example 1 except that the temperature of the heat-treated isotropic pitch of Example 4 was raised from 200° C. to 650° C. at a rate of 200° C./hour, and was then kept for 2 hours to perform activation (yield: 73%). The results obtained are shown in Table 1.

### Example 6

The same procedure as described in Example 4 was conducted except that the temperature of the isotropic pitch used in Example 1 was increased to 600° C., at the rate of 200° C./hour, so as to give heat-treated isotropic pitch (yield: 84%). This material was activated in the same way as described in Example 1, to prepare activated carbon (yield: 65%). The results obtained are shown in Table 1.

### Example 7

The same procedure as described in Example 4 was conducted except that the temperature of the materials used in Example 1 was increased to 800° C., at a rate of 20⁰° C./hour, so as to give heat-treated isotropic pitch (yield: 79%). This material was activated in the same way as described in Example 1, to prepare activated carbon (yield: 79%). The results obtained are shown in Table 1.

### Example 8

The same procedure as described in Example 4 was conducted except that the temperature of isotropic pitch which was rendered infusible and had an oxygen concentration of 3% and a softening point of 297° C. was increased to 950° C., at a rate of 200° C./hour, so as to give heat-treated isotropic pitch (yield: 74%). This material was activated in the same way as described in Example 1, to prepare activated carbon. The results obtained are shown in Table 1.

### Example 9

The same procedure as described in Example 1 was conducted except that isotropic pitch (oxygen concentration: 1.54) which was not rendered infusible was used, to prepare activated carbon (yield: 75%). The results obtained are shown in Table 1.

### Example 10

The temperature of isotropic pitch (oxygen concentration: 1.54) which was not rendered infusible was increased to 700° C., at a rate of 200° C./hour, and the elevated temperature was held for 2 hours, so as to give heat-treated isotropic pitch. This material was activated in the same way as described in Example 1, to prepare activated carbon. The results obtained are shown in Table 1.

### Example 11

To 5 g of the isotropic pitch of Example 1 was added 10 g of pulverized potassium hydroxide, and then the temperature of the pitch was increased to 160° C. at a temperature-increasing rate of 2 t/minute while the pitch was stirred in a flow of nitrogen (flow rates 300 mL/minute). Thus, the surface of the pitch was moistened. The pitch was then kept at 160 ° C. for 2 hours to eliminate the moisture, thereby converting the pitch to the solid state. A sample in lump form was placed on a plate made of SUB304 in the flow of nitrogen (flow rate: 50 mL/minute). The temperature of the pitch was increased to 700° C. at a rate of 200° C./hour. The elevated temperature was then held for 1 hour to complete the activation. Up to the end of the activation, the form of the pitch was solid. After the activation, the pitch was cooled and CO₂ gas was introduced into the tubular reaction furnace. Next, nitrogen gas was passed into an air-washing bottle containing pure water, and the nitrogen gas containing water vapor was introduced in the reaction tube. Washing with an aqueous alkali, washing with water and washing with 0.1 N hydrochloric acid solution were performed, and subsequently washing with water was repeated. Thereafter, the washed product was dried by a hot-wind drier and a vacuum drier, to give activated carbon. The results obtained are shown in Table 1. The activated carbon was subjected to wet decomposition to measure the amounts of metals present in the activated carbon and the amounts of metals present in the activated carbon of Example 1 by means of an inductivity coupled plasma (ICP) measuring apparatus (ICP optical emission spectrometer IRISAP product by Jarrell Ash). The results are shown in Table 2.

### Example 12

Activated carbon was prepared in the same way as described in Example 4 except that the temperature of the isotropic pitch used in Example 4 was increased from 200° C. to 600° C. at a rate of 200° C./hour and the pitch was kept at 600° C. for 5 hours to activate the pitch (yield: 82%). The results obtained are shown in Table 1.

### Example 13

Activated carbon was prepared in the same way as described in Example 1 except that 12 g (200 parts by weight in relative to 104 parts ref the isotropic pitch) of pulverized sodium hydroxide was added, as an activating agent, to the material used in Example 4 and the temperature of the resultant mixture was increased from 200° C. to 600° C. over 2, hours and the elevated temperature was held for 2 hours (yield: 91%). The results obtained are shown in Table 1.

### Example 14

Activated carbon was prepared in the same way as described in Example 1 except that 6 g of isotropic pitch (oxygen concentration: 1.5%) having an average particle diameter of 10 mm was used. The results obtained are shown in Table 1.

### Example 15

Activated carbon was prepared in the same way as in Example 4 except that the amount of used potassium hydroxide was set to 6 g (100 parts by weight in relative to 100 parts by weight of the isotropic pitch) (yield=85%). The results obtained are shown in Table 1.

### Example 16

Activated carbon was prepared in the same way as described in Example 4 except that the amount of potassium hydroxide used was set to 9 (150 parts by weight in relative to 100 parts by weight of the isotropic pitch) (yield: 71%). The results obtained are shown in Table 1.

### Example 17

Activated carbon was prepared in the same way as described in Example 1 except that 6 g of the isotropic pitch of Example 1 was used and 24 g (400 parts by weight in relative to 104 parts by weight of the isotropic pitch) of potassium hydroxide was used (yield: 48%). The results obtained are shown in Table 1.

### Example 18

Activated carbon was prepared in the same way as described in Example 4 except that the temperature of the isotropic pitch used in Example 4 was increased from 200° C. to 500° C. at a rate of 200° C./hour to reach 500° C. and immediately thereafter the pitch was cooled to activate the pitch(yield: 87%). The results obtained are shown in Table 1.

### Example 19

A 5 g amount of isotropic pitch used in Example 4 was placed in a quartz glass boat and the boat was introduced into a tubular reaction furnace having a diameter of 4 cm. The system was kept at 850° C. for 4 hours in a current of a mixed gas of water vapor and nitrogen. The flow rates of water vapor and nitrogen were adjusted to 0.15 mL/minute and 100 mL/minute (which were converted values at 25 ° C.), respectively (yield: 48%). The resultant product was cooled, washed with water, and dried to give activated carbon. The results obtained are shown in Table 1.

### Comparative Example 1

A 10 g amount of a carbonized shell of a coconut was placed in a quartz glass boat and the boat was introduced into a tubular reaction furnace having a diameter of 4 cm. The system was held at 700° C. for 1 hour in a flow of a mixed gas of water vapor and nitrogen. The partial pressure ratio of water vapor was adjusted to 0.67. The resultant product was cooled, washed with water, arid dried to give activated carbon (yield: 72%). The results obtained are shown in Table 1. As is evident from the results, the electrostatic capacitances of the activated carbons of Examples 1 to 19 were higher than that of the coconut shell type activated carbon of Comparative Example 1.

### Comparative Example 2

Ten grams of natural meso phase pitch [“MPM-BL” (trade name: product by Adchemco Corp.)] were placed in a quartz glass boat, and the boat was introduced into a tubular reaction furnace having a diameter of 4 cm. The temperature of the system was increased to 800 ° C. over 4 hours in a flow of nitrogen (flow rate: 500 mL/minute). The increased temperature was held for 2 hours. Thereafter, the system was cooled to give heat-treated meso phase pitch (yield: 72%). The same activation as described in Example 1 was performed to produce activated carbon. The results obtained are shown in Table 1. As is clear from the results, the electrode expansion ratios of the activated carbons of Examples 1 to 19 were lower than that of the meso phase pitch type activated carbon of Comparative Example 2.

TABLE 1

| | | | Amount | | | | | | | | | |
|---|---|---|---|---|---|---|---|---|---|---|---|---|
| | | | of the | Heat- | | | | Amount | | | | |
| | | | activating | treating | Average | | specific | of | | | | Electrode |
| | | | agent | conditions | particle | | surface | functional | | Electrode | Electrostatic | expansion |
| | | Activating | (weight | before the | diameter | Activating | area | groups | D | density | capacitance | ratio |
| | Material | agent | ratio) | activation | (μm) | conditions | (m²/g) | (meq/g) | ratio | (g/m) | (F/cc) | (%) |
| Example 1 | isotropic | KOH | 2.0 | — | 20 | 700° C. × | 2060 | 1.9 | 2.8 | 0.52 | 20.2 | −5 |
| | pitch | | | | | 1 hr | | | | | | |
| Example 2 | isotropic | KOH | 2.0 | — | 20 | 800° C. × | 2710 | 1.3 | 2.5 | 0.48 | 18.5 | −4 |
| | pitch | | | | | 2 hr | | | | | | |
| Example 3 | isotropic | KOH | 2.0 | — | 12 | 700° C. × | 1830 | 1.8 | 2.4 | 0.5 | 21.9 | −2 |
| | pitch | | | | | 1 hr | | | | | | |
| Example 4 | isotropic | KOH | 2.0 | 700° C. × | 6 | 700° C. × | 1310 | 1.4 | 2.6 | 0.65 | 25.5 | −1 |
| | pitch | | | 2 hr | | 1 hr | | | | | | |
| Example 5 | isotropic | KOH | 2.0 | 700° C. × | 6 | 650° C. × | 1730 | 2.0 | 2.6 | 0.82 | 22.5 | −1 |
| | pitch | | | 2 hr | | | | | | | | |
| Example 6 | isotropic | KOH | 2.0 | 600° C. × | 20 | 700° C. × | 2000 | 1.7 | 2.4 | 0.6 | 22.5 | 3 |
| | pitch | | | 2 hr | | 1 hr | | | | | | |
| Example 7 | isotropic | KOH | 2.0 | 800° C. × | 20 | 700° C. × | 620 | 1.1 | 2.7 | 0.95 | 23.1 | 15 |
| | pitch | | | 2 hr | | 1 hr | | | | | | |
| Example 8 | isotropic | KOH | 2.0 | 950° C. × | 20 | 700° C. × | 160 | 0.3 | 2.9 | 1.07 | 21.8 | 17 |
| | pitch | | | 2 hr | | 1 hr | | | | | | |
| Example 9 | isotropic | KOH | 2.0 | — | 20 | 700° C. × | 2440 | 1.7 | 2.4 | 0.57 | 17.3 | −2 |
| | pitch | | | | | 1hr | | | | | | |
| Example | isotropic | KOH | 2.0 | 700° C. × | 20 | 700° C. × | 720 | 1.3 | 2.4 | 0.91 | 20.1 | 6 |
| 10 | pitch | | | 2 hr | | 1 hr | | | | | | |
| Example | isotropic | KOH | 2.0 | — | 20 | 700° C. × | 1660 | 0.7 | 2.8 | 0.64 | 24.2 | −3 |
| 11 | pitch | | | | | 1 hr | | | | | | |
| Example | isotropic | KOH | 2.0 | 700° C. × | 6 | 600° C. × | 1660 | 2.0 | 2.5 | 0.72 | 22.1 | 1 |
| 12 | pitch | | | 2 hr | | 5 hr | | | | | | |
| Example | isotropic | NaOH | 2.0 | 700° C. × | 6 | 600° C. × | 1080 | 1.5 | 2.8 | 0.85 | 20 | 0 |
| 13 | pitch | | | 2 hr | | 2 hr | | | | | | |
| Example | isotropic | KOH | 2.0 | — | 1 × 10⁴ | 700° C. × | 1280 | 1.1 | 2.9 | 1.13 | 10.1 | −5 |
| 14 | pitch | | | | | 1 hr | | | | | | |
| Example | isotropic | KOH | 1.0 | 700° C. × | 6 | 700° C. × | 1490 | 1.3 | 2.4 | 0.87 | 13 | −7 |
| 15 | pitch | | | 2 hr | | 1 hr | | | | | | |
| Example | isotropic | KOH | 1.5 | 700° C. × | 6 | 700° C. × | 1530 | 1.3 | 2.5 | 0.75 | 21.5 | 2 |
| 16 | pitch | | | 2 hr | | 1 hr | | | | | | |
| Example | isotropic | KOH | 4.0 | — | 20 | 700° C. × | 3570 | 2.6 | 2.5 | 0.36 | 14.9 | −8 |
| 17 | pitch | | | | | 1 hr | | | | | | |
| Example | isotropic | KOH | 2.0 | 700° C. × | 6 | 500° C. × | 190 | 1.1 | 3.6 | 1.12 | 3.3 | −4 |
| 18 | pitch | | | 2 hr | | 0 hr | | | | | | |
| Example | isotropic | Steam | — | 700° C. × | 6 | 850° C. × | 960 | 0.2 | 3.7 | 0.91 | 13.5 | −3 |
| 19 | pitch | | | 2 hr | | 4 hr | | | | | | |
| Com- | coconut | Steam | — | — | 60 | 700° C. × | 560 | 0.1 | 3.7 | 0.94 | 0.6 | 0 |
| parative | shell | | | | | 1 hr | | | | | | |
| Example 1 | | | | | | | | | | | | |
| Com- | Meso | KOH | — | 800° C. × | 15 | 700° C. × | 120 | 0.7 | 3.1 | 1.11 | 21.1 | 44 |
| parative | phase | | | 2 hr | | 1 hr | | | | | | |
| Example 2 | pitch | | | | | | | | | | | |

TABLE 2

| | Cr | Fe | Cu | Ni | Zn | Total |
|---|---|---|---|---|---|---|
| | Content | content | content | content | content | amount |
| | (ppm) | (ppm) | (ppm) | (ppm) | (ppm) | (ppm) |
| Example 1 | 18.9 | 22.4 | 2.2 | 20.1 | 6.8 | 70.4 |
| Example | 8.2 | 12.4 | 2.1 | 0.7 | 11.8 | 35.2 |

According to the present invention, it is possible to provide activated carbon which is made from granular isotropic pitch, and a process far producing the same. Upon forming the activated carbon of the present invention into polarizable electrodes and combining the electrodes with current electrodes and an electrolyte solution, a capacitor which has a large electrostatic capacitance and is superior in low-expandibility of the electrodes at the time of charging can be made.

The disclosure of Japanese priority Application Number 223680/2000 filed Jul. 25, 2000 is hereby incorporated by reference into the present application.

Obviously, numerous modifications and variations of the present invention are possible in light of the above teachings. It is, therefore, to be understood that within the scope of the appended claims, the invention may be practiced otherwise than as specifically described herein

What is claimed as new and is intended to be secured by Letters Patent is:

1. Activated carbon which is prepared from granular isotropic pitch.

2. The activated carbon according to claim 1, wherein the granular isotropic pitch has an average particle diameter of 10 mm or less.

3. The activated carbon according to claim 1, which has a specific surface area of 100 to 4000 m²l/g.

4. The activated carbon according to claim 1, wherein the total amount of surf ace functional groups is 2.5 meq/g or less.

5. The activated carbon according to claim 1, wherein the half band width of a peak indicating the D band of amorphous carbon is 1 to 4 times larger than that of a peak indicating the D band of graphite carbon in Raman spectra.

6. A process for producing activated carbon, which comprises:
activating granular isotropic pitch with a chemical agent.

7. The process according to claim 6, wherein at least one part of the chemical agent is a compound of an alkali metal element, a compound of an alkaline earth metal element, zinc chloride, sulfuric said, or phosphoric acid.

8. The process according to claim 6, wherein the chemical agent is potassium hydroxide or sodium hydroxide.

9. The process according to claim 6, wherein the temperature of activation with the chemical agent ranges from 500 to 900° C.

10. The process according to claim 6, wherein the amount of chemical agent ranges from 100 to 400 parts by weight in relative to 100 parts by weight of the isotropic pitch.

11. The process according to claim 6, wherein the activating step comprises a pitch-moistening step of moistening at least the surface of the isotropic pitch at a temperature of 200° C. or lower, a pitch-solidifying step of eliminating moisture at a temperature of 400° C. or less, and a pitch heat-treating step of heat-treating the solid at a temperature over 400° C. with maintaining the solid state of the pitch.

12. A process for producing activated carbon, which comprises:
infusiblizing granular isotropic pitch and subsequently activating the pitch with a chemical agent.

13. The process according to claim 12, wherein at least one part of the chemical agent is a compound of an alkali metal element, a compound of an alkaline earth metal element, zinc chloride, sulfuric said, or phosphoric acid.

14. The process according to claim 12, wherein the chemical agent is potassium hydroxide or sodium hydroxide.

15. The process according to claim 12, wherein the temperature of activation with the chemical agent ranges from 500° C. to 900° C.

16. The process according to claim 12, wherein the amount of chemical agent ranges from 100 to 400 parts by weight in relative to 100 parts by weight of the isotropic pitch.

17. The process according to claim 12, wherein the activating step comprises a pitch-moistening step of moistening at least the surface of the isotropic pitch at a temperature of 200° C. or lower, a pitch-solidifying step of eliminating moisture at a temperature of 400° C. or less, and a pitch heat-treating step of heat-treating the solid at a temperature over 400° C. with maintaining the solid state of the pitch.

18. A process for producing activated carbon, which comprises:
heat treating granular isotropic pitch and subsequently activating the pitch with a chemical agent.

19. The process according to claim 18, wherein at least one part of the chemical agent is a compound of an alkali metal element, a compound of an alkaline earth metal element, zinc chloride, sulfuric said, or phosphoric acid.

20. The process according to claim 18, wherein the chemical agent is potassium hydroxide or sodium hydroxide.

21. The process according to claim 18, wherein the temperature of activation with the chemical agent ranges from 500° C. to 900° C.

22. The process according to claim 18, wherein the amount of chemical agent ranges from 100 to 400 parts by weight in relative to 100 parts by weight of the isotropic pitch.

23. The process according to claim 18, wherein the activating step comprises a pitch-moistening step of moistening at least the surface of the isotropic pitch at a temperature of 200° C. or lower, a pitch-solidifying step of eliminating moisture at a temperature of 400° C. or less, and a pitch heat-treating step of heat-treating the solid at a temperature over 400° C. with maintaining the solid state of the pitch.

24. A process for producing activated carbon, which comprises:
infusiblizing granular isotropic pitch and then heat-treating and subsequently activating the pitch with a chemical agent.

25. The process according to claim 24, wherein at least one part of the chemical agent is a compound of an alkali metal element, a compound of an alkaline earth metal element, zinc chloride, sulfuric said, or phosphoric acid.

26. The process according to claim 24, wherein the chemical agent is potassium hydroxide or sodium hydroxide.

27. The process according to claim 24, wherein the temperature of activation with the chemical agent ranges from 500° C. to 900° C.

28. The process according to claim 24, wherein the amount of chemical agent ranges from 100 to 400 parts by weight in relative to 100 parts by weight of the isotropic pitch.

29. The process according to claim 24, wherein the activating step comprises a pitch-moistening step of moistening at least the surface of the isotropic pitch at a temperature of 200° C. or lower, a pitch-solidifying step of eliminating moisture at a temperature of 400° C. or less, and a pitch heat-treating step of heat-treating the solid at a temperature over 400° C. with maintaining the solid state of the pitch.

30. A polarizable electrode which is prepared by mixing the activated carbon of claim 1 with at least a binder and an electroconductive filler.

31. The polarizable electrode according to claim 30, which is a coat electrode prepared by applying a paste mixture containing the activated carbon to a surface.

32. The polarizable electrode according to claim 30, which is a sheet electrode prepared by forming the mixture into a sheet.

33. The polarizable electrode according to claim 30, which has an electrode density of 0.3 g/cm³ or more.

34. The polarizable electrode according to claim 31, which has an electrode density of 0.3 g/cm³ or more.

35. The polarizable electrode according to claim 32, which has an electrode density of 0.3 g/cm³ or more.

36. An electric double layer capacitor composed essentially of a pair of polarizable electrodes, a current collector set onto each of the polarizable electrodes, and an electrolyte solution, wherein at least one of the polarizable electrodes is the polarizable electrode according to claim 30.

37. An electric double layer capacitor composed essentially of a pair of polarizable electrodes, a current collector set onto each of the polarizable electrodes, and an electrolyte solution, wherein at least one of the polarizable electrodes is the polarizable electrode according to claim 31.

38. An electric double layer capacitor composed essentially of a pair of polarizable electrodes, a current collector set onto each of the polarizable electrodes, and an electrolyte solution, wherein at least one of the polarizable electrodes is the polarizable electrode according to claim 32.

39. The electric double layer capacitor according to claim 36, wherein the expansion ratio of the polarizable electrodes is 40% or less after charging and discharging.

40. The electric double layer capacitor according to claim 37, wherein the expansion ratio of the polarizable electrodes is 40% or less after charging and discharging.

41. The electric double layer capacitor according to claim 38, wherein the expansion ratio of the polarizable electrodes is 40% or less after charging and discharging.
